(19) United States
(12) Patent Application Publication
(10) Pub. No.: US 2002/0178794 A1
(43) Pub. Date: Dec. 5, 2002

(54) Leakage detecting instrument

(76) Inventor: Kuei-Chung Liao, Feng-Yuan City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/870,526

(22) Filed: May 30, 2001

(51) Int. Cl. G01M 3/04

(52) U.S. Cl. 73/49.8

(57) ABSTRACT

A leakage detecting instrument includes a connecting device (1) and an air-inlet device (2) combined with the connecting device (1). The connecting device (1) has a cap (10) adapted to be firmly secured on an inlet tube (31) of a water tank (30) and a screw rod (13) rotably penetrates the cap (10). The screw rod (13) supportably extends between the cap (10) and the inlet tube (31) to provide resistance to an internal pressure of the water tank (30) when air is compressed into the water tank to detect leakage.

### BACKGROUND OF THE INVENTION

1. Field of the Invention

The present invention relates to a leakage detecting instrument, and more particularly to a leakage detecting instrument for a water tank (radiator) of a car.

2. Description of Related Art

A radiator in a car is an essential heat dispersing device for cooling the engine of the car. Most radiators have a water tank to store water inside and a pump to circulate the water from the water tank to a radiator grill to reduce a temperature of the engine. If the radiator does not work efficiently, the engine will quickly overheat and probably seize up internally due to the over-expansion of components. Therefore, to ensure reliability of the car, the radiator and water pump etc need to be well maintained and repaired promptly in event of malfunction. In particular, the water circulating system needs to be checked for leakage as this is a common cause of failure of the system. However, one problem is that some leaks might so slow that the source cannot be traced, yet the flow rate of the leak is still sufficient to cause eventual overheating of the engine.

A conventional leakage detecting instrument shown in FIG. 6 is adapted to be secured on a corresponding water tank (70). The water tank (70) has an inlet tube (71) defined therein for receiving water, and two outer guide tracks (72) oppositely formed at a top of the inlet tube (71). Each guide track (72) has a stub (73) extending downwardly from an end face of the guide track (72). A ring (75) is formed on and extends from an inner periphery of the inlet tube (71) and a flange (76) is erected on the ring (75) as concentric circle with the inlet tube (71).

The conventional leakage detecting instrument is composed of a cover (80) with two ears (81), a tube (82), a spring (83), a positioning plate (84), and a cushion (85). The ears (81) extend oppositely from the cover (80) whereby a user can apply significant torque to the cover (80) so as to secure well the cover (80) easily. The tube (82) penetrates the cover (80) and has one end connected to an air pump (88) and the other end of the tube (82) is secured on the positioning plate (84) to convey air. The spring (83) is coiled around the tube (82) between the cover (80) and the positioning plate (84) to resiliently urge the positioning plate (84) away from the cover (80). The cushion (85) is fitted to an under face of the positioning plate (84). Additionally, two teeth (801) are formed inwardly and oppositely on a bottom edge of the cover (80) to correspond to the inlet tube (71) of the water tank (70).

When the conventional leakage detecting instrument is in use, the positioning plate (84) is inserted inside the inlet tube (71) and stopped by the flange (76) of the ring (75). Meanwhile, the cover (80) is combined with the guide tracks (72) at a downward side wall by teeth (801) of the cover (80) extending into and sliding along the guide tracks (72). The cushion (85) is urged by the spring (83) to abut the flange (76) to enhance the sealing effect to the water tank (70). To check any leakage of the water tank (70), the pump (88) compresses air into the water tank (70) whereby the pressure inside the water tank (70) rises to such an extent that water is expelled from the water tank (70) and source of the leakage becomes apparent. Furthermore, the instrument can be used in a routine maintenance check whereby a pressure gauge fitted to the pump (88) will indicate a leak previously unknown.

However, multiple disadvantages exist with this type of instrument and are listed as follows:

1. restricted application: This conventional leakage detecting instrument is not suitable for all kinds of cars because depths of the inlet tubes (71) are different and a length of the spring (83) on the tube (82) is fixed. Thus, a repair shop may need to have many such instruments to meet all the different types of vehicle.

2. weak sealing effect: The sealing effect is controlled by the elastic potential energy of the spring (83) when the spring is compressed. Therefore, when the depth of the inlet tube (71) is too long and the spring (83) is completely extended in the inlet tube (71), the force directed on the cushion (85) is weak. Thus, when the pump (88) compresses air into the water tank (70) and the pressure of the water tank (70) rises, compressed air is easily released from the cushion (85) because the pressure within the water tank (70) is higher than the compression strength of the spring (83).

3. Unreliability: The resilience of the spring (83) tends to weaken after use for a period of time, whereby the leakage detecting instrument is unreliable and must be replaced.

Because of those shortcomings of the conventional leaking detecting instrument, the present invention has arisen to mitigate and/or obviate the said disadvantages.

### SUMMARY OF THE INVENTION

The main objective of the present invention is to provide a leakage detecting instrument that seals a water tank tightly so as to enable precise and efficient detection of leakage of the water tank.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a leakage detecting instrument in accordance with the present invention;

FIG. 2 is an exploded perspective view of a connecting device of the leakage detecting instrument in accordance with FIG. 1;

FIG. 3 is an exploded plan view of an air-inlet device of the leakage detecting instrument in accordance with FIG. 1;

FIG. 4 is a cross-sectional view of the connecting device of the leakage detecting instrument;

FIG. 5 is an enlarged cross-sectional view showing an alternative embodiment of the leakage detecting instrument; and

FIG. 6 is a perspective view of a conventional leakage detecting instrument.

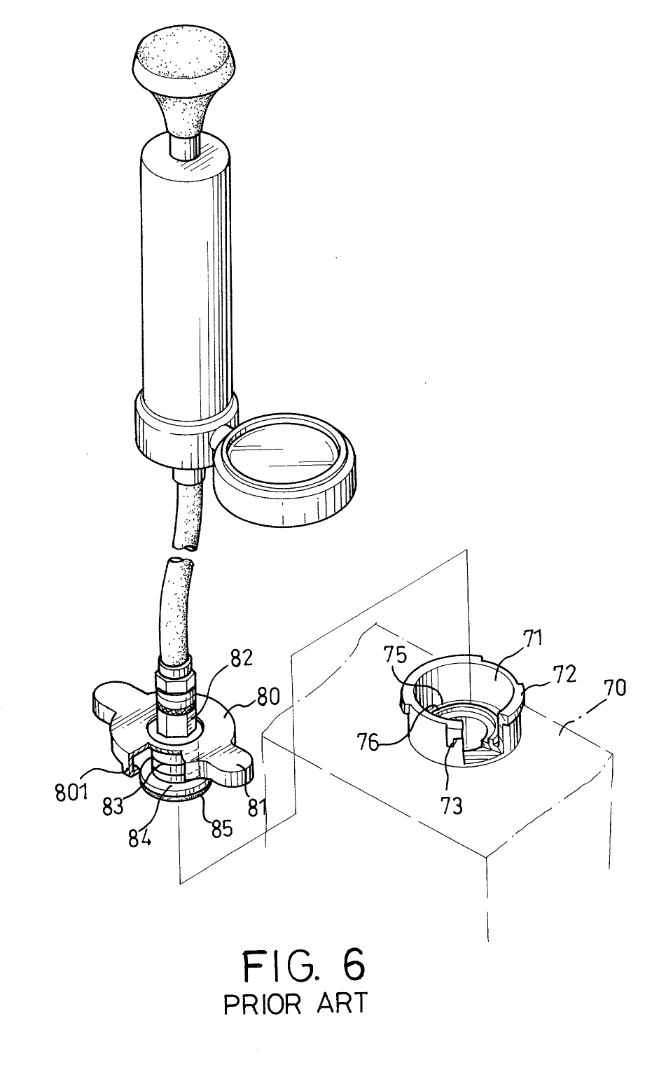

### DETAILED DESCRIPTION OF THE INVENTION

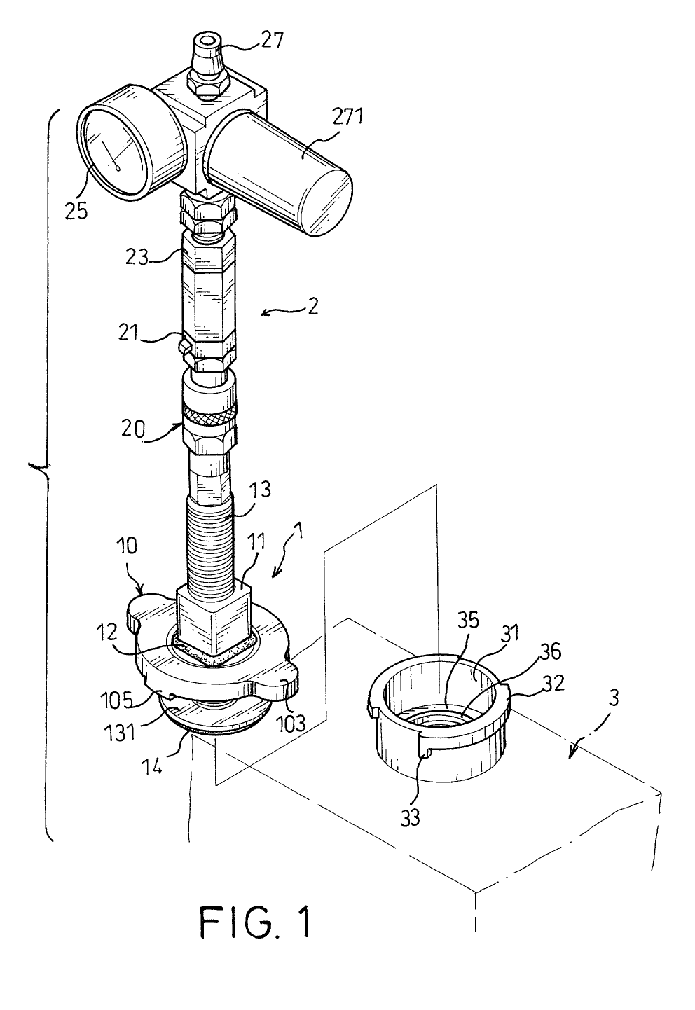

With reference to FIG. 1, a leakage detecting instrument in accordance with the present invention comprises a connecting device (1) and an air-inlet device (2) screwingly connected to the connecting device (1), and the leakage detecting instrument is adapted to secured on a water tank (3).

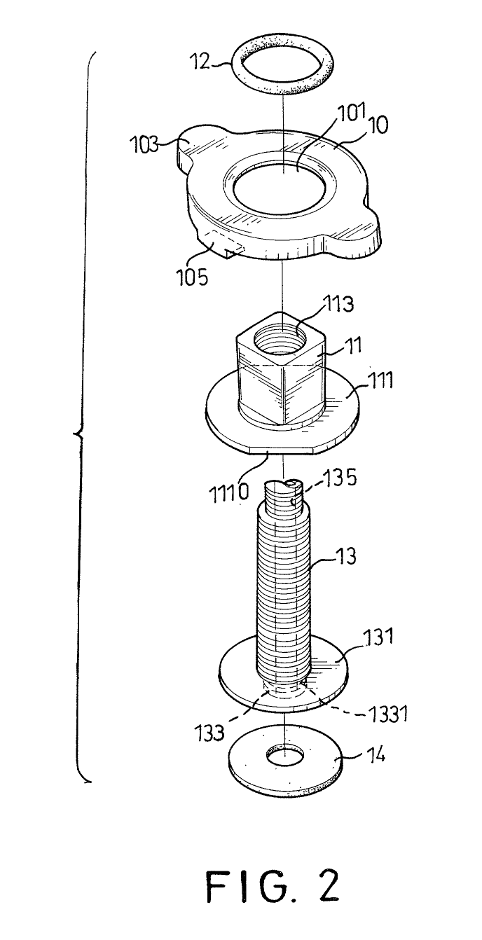

Now referring to FIG. 2, the connecting device (1) has a cap (10), a union (11), a ring (12), a screw rod (13), and a gasket (14).

The cap (10) has a hole (101) defined therein and two wings (103) formed at opposite sides of the cap (10) to enable users to easily turn the cap (10). Two flanges (105) are formed oppositely and perpendicular in respect with the two wings (103). The flanges (105) protrude inwardly under the cap (10) to interlock with the water tank (3).

The union (11) is a cubic nut received in the hole (101) of the cap (10) and has a resilient plate (111) formed on an under face of the cubic nut. The union (11) has a threaded hole (113) extending between the resilient plate (111) and a top face of the cubic nut, and the threaded hole receives part of the screw rod (13) inside. The resilient plate (111) has two flat edges (1110) to avoid interfering with the flanges (105) of the cap (10) when the union (11) is inserted in the cap (10). The ring (12) is resilient and adapted to bind tightly the union (11) to keep the union (11) in a desired position.

The screw rod (13) extended through the threaded hole (113) of the union (11) is connected with the air-inlet device (2), as shown in FIGS. 1, 2 and 4, and has a thread defined in a periphery thereof to correspond to the threaded hole (113) of the union (11). A positioning plate (131) is formed around a bottom portion of the screw rod (13) and a bud (133) is formed under the positioning plate (131). A notch (1331) is defined in a periphery of the bud (133) and near the positioning plate (131). A channel (135) is defined longitudinally through the whole screw rod (13) including the positioning plate (131) and the bud (133). The gasket (14) is secured in the notch (1331).

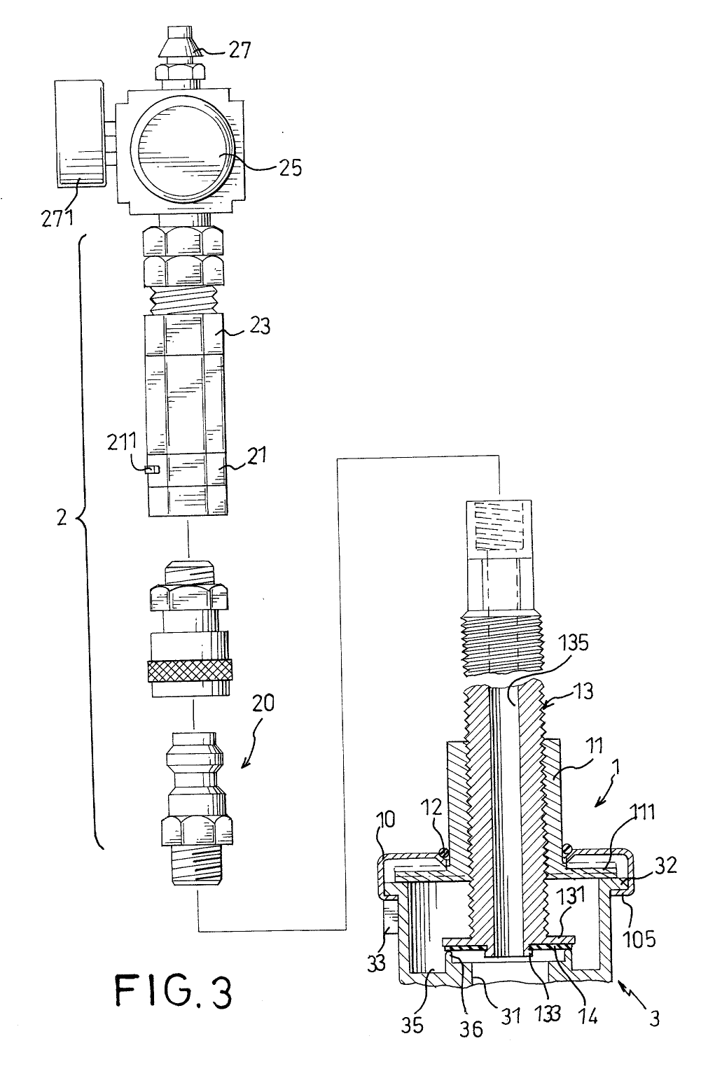

With reference to FIG. 3, the air-inlet device (2) is composed of a joint (20), a pressure reducing valve (21), a check valve (23), a pressure gauge (25), and a connector (27) with a control wheel (271).

The joint (20) is combined with the screw rod (13) of the connecting device (1) by screwing a threaded bottom end of the joint (20) into a threaded socket defined in the top end of the screw rod (13). The pressure reducing valve (21) is mounted firmly on the joint (20) and has a press button (211) secured on the pressure reducing valve (21) to release the pressure. The check valve (23) is communicated with the pressure reducing valve (21) to avoid air flowing back to the connector (27) when the leakage detecting instrument is operating. The connector (27) mounted on the check valve (23) connects with an air compressor (not shown). The pressure gauge (25) is fitted on the connector (27) to enable an operator to read the total pressure of the injected air. The control wheel (271) is fixed on the connector (27) to enable adjustment of a required level of the pressure aFchieved by adding air to the water tank (3).

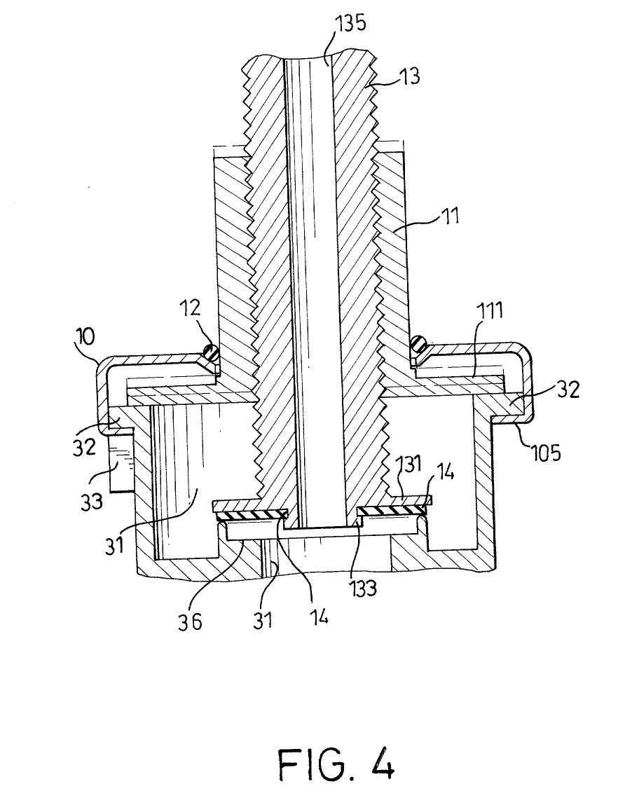

Referring to FIGS. 1 and 4, the water tank (3) has an inlet tube (31) defined therein for receiving water and two guide tracks (32) formed laterally and partly at a top of the inlet tube (31). Each guide track (32) has a stub (33) formed vertically and downwardly at one end thereof. A platform (35) is formed on an inner periphery of the inlet tube (31) and a protrusion (36) is erected on a top face of the platform (35).

Still referring to FIG. 4, when the leakage detecting instrument is in use, the cap (10) interlocks with the inlet tube (31) by the flanges (105) of the cap (10) being passed through spaces between the two guide tracks (32), and then the cap (10) is turned clockwise until each flange (105) touches the respective stub (33) of the inlet tube (31), whereby the flanges (105) are firmly secured under the guide tracks (32). Meanwhile, the resilient plate (111) touches the guide tracks (32) and the screw rod (13) is inserted into the inlet tube (31) with the gasket (14) secured under the positioning plate (131) firmly abutting the protrusion (36) of the inlet tube (31) to resist the pressure from the water tank (3).

Then the union (11) is turned in counter-clockwise to make the union (11) move upwardly so that the resilient plate (111) accordingly moves upwardly (as shown in dotted lines) to touch and resist the cap (10). The cap (10) gives a reacting force to the screw rod (13) to enhance the pressuring force of the positioning plate (131). Therefore, the screw rod (13) inside the inlet tube (31), i.e. between the positioning plate (131) and the resilient plate (111), prevents leaking air when the air compressor inputs air into the water tank (3).

Additionally, the screw rod (13) does not have resilient exhaustion as the spring does in the conventional leakage detecting instrument and the screw rod (13) enables adjustment of the length of the disclosed leakage detecting instrument to configure with different depths of different inlet tube (31).

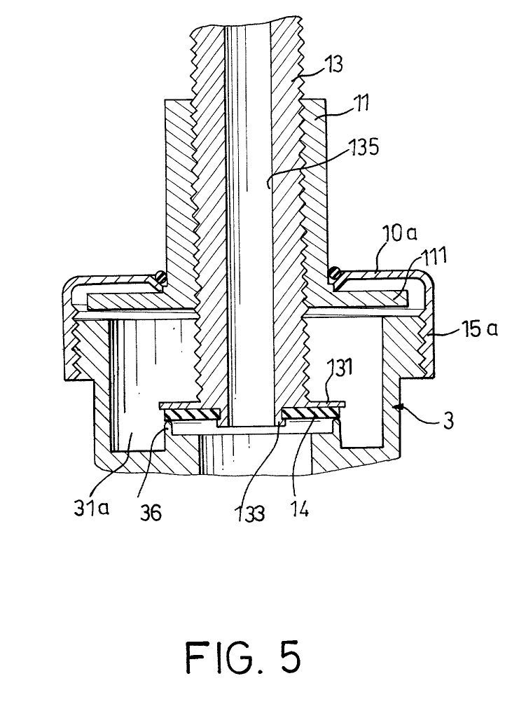

FIG. 5 shows another embodiment wherein the inlet tube (31a) has different shape with a threaded surface formed on the guide tracks (15a). Therefore, the present leakage detecting instrument has another cap (10a) that corresponds to the threaded guide tracks (15a).

Although the invention has been explained in relation to its preferred embodiment, it is to be understood that many other possible modifications and variations can be made without departing from the spirit and scope of the invention as hereinafter claimed.

What is claimed is:

1. A leakage detecting instrument for a container having an inlet tube, the leakage detecting instrument comprising:
a connecting device (1) adapted to be mounted on the inlet tube and having
a cap (10) interlockable with the inlet tube;
a union (1) rotatably extending through the cap (10) and having a resilient plate (111) secured around the union (11) and a threaded hole (113) defined in the union (11);
an air-inlet device (2) detachably mounted on the connecting device (1), and adapted to connect with an air compressor to provide air in the container via the connecting device (1); and
a screw rod (13) connecting to the air-inlet device (2) and extending through the threaded hole (113) of the union (11), and the screw rod having a positioning plate (131) secured around the screw rod (13) so as to abut the inlet tube, and a channel (135) defined through the screw rod (13), wherein the channel (135) communicates with the air-inlet device (2).

2. The leakage detecting instrument as claimed in claim 1, wherein the air inlet device (2) comprising:
a joint (20) firmly connected with the screw rod (13);
a pressure reducing valve (21) mounted firmly on the joint (20) to release pressure of the container;
a check valve (23) communicated with the pressure reducing valve (21) to avoid air flowing away from the water tank when the leakage detecting instrument is operating;
a connector (27) mounted on the check valve (23) and connected with the air compressor;
a pressure gauge (25) secured on the connector (27) to indicate a level of pressure inside the container; and
a control wheel (271) fixed on the connector (27) to adjust pressure of air being inputted to the container.

3. The leakage detecting instrument as claimed in claim 1, wherein a ring (12) is securely mounted around a corner junction between the union (11) and the cap (10) to position the union (11).

4. The leakage detecting instrument as claimed in claim 2, wherein a ring (12) is securely mounted around the at a corner junction between the union (11) and the cap (10) to position the union (11).

5. The leakage detecting instrument as claimed in claim 1, wherein a gasket (14) is correspondingly secured under the positioning plate (131) of the screw rod (13) to enhance a leak prevention effect.

6. The leakage detecting instrument as claimed in claim 2, wherein a gasket (14) is correspondingly secured under the positioning plate (131) of the screw rod (13) to enhance a leak prevention effect.

7. The leakage detecting instrument as claimed in claim 1, wherein a gasket (14) is correspondingly secured under the positioning plate (131) of the screw rod (13) to enhance a leak prevention effect.

8. The leakage detecting instrument as claimed in claim 1, wherein the cap (10) has two wings (103) formed on opposite sides of the cap (10) to provide a sure grip by a user of the cap (10), and two flanges (105) formed inwardly and extending under the cap (10) to interlock with the inlet tube of the container.

9. The leakage detecting instrument as claimed in claim 2, wherein the cap (10) has two wings (103) formed on opposite sides of the cap (10) to provide a sure grip by a user of the cap (10), and two flanges (105) formed inwardly and extending under the cap (10) to interlock with the inlet tube of the container.

10. The leakage detecting instrument as claimed in claim 3, wherein the cap (10) has two wings (103) formed on opposite sides of the cap (10) to provide a sure grip by a user of the cap (10), and two flanges (105) formed inwardly and extending under the cap (10) to interlock with the inlet tube of the container.

11. The leakage detecting instrument as claimed in claim 5, wherein the cap (10) has two wings (103) formed on opposite sides of the cap (10) to provide a sure grip by a user of the cap (10), and two flanges (105) formed inwardly and extending under the cap (10) to interlock with the inlet tube of the container.

12. The leakage detecting instrument as claimed in claim 1, wherein the resilient plate (111) of the union (11) has two flat edges (1110) to align respectively with the flanges (105) of the cap (10) when the union (11) is received in the cap (10).

13. The leakage detecting instrument as claimed in claim 11, wherein the resilient plate (111) of the union (11) has two flat edges (1110) to align respectively with the flanges (105) of the cap (10) when the union (11) is received in the cap (10).

14. The leakage detecting instrument as claimed in claim 1, wherein the screw rod (13) has a bud (133) formed under the positioning plate (131) and a notch (1331) is defined in the bud (133) to retain the gasket (14) in the notch (1331).

15. The leakage detecting instrument as claimed in claim 13, wherein the screw rod (13) has a bud (133) formed under the positioning plate (131) and a notch (1331) is defined in the bud (133) to securely receive the gasket (14).
